(19) United States
(12) Patent Application Publication
(10) Pub. No.: US 2006/0188803 A1
(43) Pub. Date: Aug. 24, 2006

(54) Electrophotographic image forming apparatus, electrophotographic image forming method, and electrophotographic photoreceptor

(75) Inventors: Shinichi Yabuki, Kanagawa (JP); Takeshi Kakutani, Kanagawa (JP); Takeshi Ishida, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Business Technologies, Inc.

(21) Appl. No.: 11/299,809

(22) Filed: Dec. 12, 2005

(30) Foreign Application Priority Data
Feb. 23, 2005 (JP) JP2005-046822

(51) Int. Cl. G03G 15/00

(52) U.S. Cl. 430/117; 399/159; 430/60; 430/132; 430/66; 430/64

(57) ABSTRACT

An electrophotographic image forming apparatus having: a photoreceptor which has a intermediate layer containing inorganic particles and a binder between a electroconductive substrate and an uppermost layer; a developing unit for developing an electrostatic latent image formed on the photoreceptor to make a toner image, the developing unit utilizing a liquid developer containing a toner and a carrier liquid; and a transferring unit for transferring the toner image onto a recording material, wherein a number-average primary particle diameter of the inorganic particles is from 5 to 300 nm, and the intermediate layer is covered with the uppermost layer.

### BACKGROUND OF THE INVENTION

1. Field of the Invention

The present invention relates to an electrophotographic image forming apparatus, an electrophotographic image forming method, an electrophotographic photoreceptor.

2. Background of the Invention

Recently, an image forming method by digital image forming system has become main current accompanied with progress in the digital technology. In the digital image forming method, a high image quality technology is required sometimes by which a small dot image of a pixel such as 1,200 dpi (dpi is number of dot per one inch or 2.45 cm) can be reproduced with high fidelity. Particularly, downsizing, high resolution ability and full color reproduction ability are demanded for copy machine, and in the case of printer, it is recently required to stably form a high quality image similar to that obtained by conventional printing method. Further progress in the high quality image technology is demanded for stably obtaining the high quality toner image.

For obtaining the high quality image, investigation on developing unit and photoreceptor has been performed.

The developing unit in the electrophotographic technology can be roughly classified into a dry developing method and a wet developing method.

The dry developing method is a method employing a powder toner, and the method can be further classified into a double-component type dry developing method employing a developer composed of a toner, a carrier and another additive is employed and a single-component type dry developing method employing a developer composed of a toner, an additive without any carrier.

Besides, the wet developing method is a method employing a liquid developer composed of a carrier liquid and a toner dispersed therein. In the wet developing method, the toner has merits that it has smaller particle size and higher transparence compared to those in the dry developing method and has strong points such as that a high quality toner image can be obtained by any of an analogue, digital, monochromatic and color systems and an image forming apparatus saving on energy can be constituted.

Concerning an electrophotographic photoreceptor for stably obtaining a high quality image, it is proposed to provide an intermediate layer between the substrate and the uppermost layer for controlling the electroconductivity between the electroconductive substrate and the photosensitive layer, cf. Patent Document 1, for example.

Moreover, regarding an electrophotographic photoreceptor for obtaining a lot of high quality toner images, it is proposed to provide an intermediate layer containing a fine particle between the substrate and the photosensitive layer and to cover the both edges of the intermediate layer by the layer for improving the adhesion of the coated layer, cf. Patent Document 2, for example.

Furthermore, a photoreceptor is proposed in which the charge generation layer and the subbing layer are covered with the charge transfer layer for preventing the corrosion of from the edge portion of the coated layers by the solvent causing the peeling off form the edge portion of the coated layer, cf. Patent Document 3, for example.

Patent Document 1: Tokkai Sho 59-184359

Patent Document 2: Tokkai 2002-107986

Patent Document 3: Tokkai Hei 9-90662

However, the coated layer is swelled or peeled off from the edge portion when such the photoreceptor is employed in a wet developing image forming apparatus. As a result of that, high quality toner image cannot be obtained by occurrence of black spots or fogging, lowering in density or sharpness during formation of a lot of prints. Thus, further improvement is demanded.

### SUMMARY OF THE INVENTION

An object of the invention is to provide an electrophotographic image forming apparatus, an electrophotographic image forming method, an electrophotographic photoreceptor and a processing cartridge by which high quality toner images can be continuously obtained.

In concrete, an object is to provide an electrophotographic image forming apparatus, an electrophotographic image forming method, an electrophotographic photoreceptor and a processing cartridge by which toner images with high density and high sharpness and without black spots and fogging can be obtained even when a large number of image is printed by the wet developing process by employing an electrophotographic photoreceptor in which an intermediate layer containing inorganic particles having a number-average particle diameter of from 5 to 300 nm is covered with the uppermost layer.

One of aspect can be an electrophotographic image forming apparatus comprising:

a photoreceptor which comprises an intermediate layer containing inorganic particles and a binder between an electroconductive substrate and an uppermost layer;

a developing unit which develops an electrostatic latent image formed on the photoreceptor to make a toner image, the developing unit utilizing a liquid developer containing a toner and a carrier liquid; and

a transferring unit which transfers the toner image to a recording material,

wherein a number-average primary particle diameter of the inorganic particles is in the range of 5 to 300 nm, and the intermediate layer is covered with the uppermost layer.

### BRIEF DESCRIPTION OF THE DRAWINGS

FIG. 1 shows a schematic cross section of an example of image forming apparatus in which an electrostatic latent image formed on a photoreceptor is developed as a toner image by a wet developing unit and the toner image is directly transferred onto a recording material.

FIG. 2 shows a schematic cross section of an example of image forming apparatus in which an electrostatic latent image formed on a photoreceptor is developed to a toner image by a wet developing unit and the toner image is transferred onto a recording material trough an intermediate transfer unit using an intermediate transfer member.

FIG. 3 shows a schematic drawing of the constitution of a liquid developing apparatus according to the invention.

FIG. 4 shows the schematic front view of a developing unit to be employed in the liquid developing apparatus for developing an electrostatic latent image shown in FIG. 3.

FIGS. 5(a), 5(b) and 5(c) each shows an example of layer construction of a photoreceptor relating to the invention.

FIG. 6 shows an example of layer construction of a comparative photoreceptor.

### DETAILED DESCRIPTION OF THE PREFERRED EMBODIMENT

It is found by the inventors that the foregoing problems are not caused and high quality toner image can be obtained even if many prints are printed when the image formation is carried out by an image forming apparatus with a wet developing unit employing carrier liquid of the present invention, hereinafter simply referred to as an image forming apparatus, and an electrophotographic photoreceptor, hereinafter simply referred to as a photoreceptor, which has an intermediate layer containing inorganic particles having a number-average primary particle diameter of from 5 to 300 nm and the edge portions of the intermediate layer are covered with the uppermost layer.

Though the reason of the above phenomenon is not cleared, it is supposed as followings.

1. Many images can be printed without peeling off of the coated layer from the edge portion of the coated layer since the permeation of the developer from the edge portion can be prevented because the intermediate layer easily dissolved or swollen by the developer for the wet development is covered by the uppermost layer not dissolved nor swollen by the developer. The adhesiveness between the substrate and the intermediate layer is lowered by addition of the surface treated inorganic particles for obtaining the high quality image so that the layer becomes easily peeling off by the permeation of the developer. The fine toner particles tend to be coagulated by mixing the inorganic particles and broken pieces of the binder formed by peeling off of the layer into the developer so that image defects such as lowering in the sharpness and adhesion of coagulated toner particles on the photoreceptor surface are caused. Particularly, when viscosity of the developer liquid becomes higher, peeling off power of the coated layer becomes larger and causes unexpectedly large damage in cases where the intermediate layer is not covered as in the present invention.

2. The black spots and fogging can be prevented because the intermediate layer containing the inorganic particles having a number-average primary particle diameter of from 5 to 300 nm effectively blocks hole-injection from the substrate and blocks electron-injection a little from the photosensitive layer.

3. Since the particle-diameter of the inorganic particle is fine, the uniform intermediate layer can be formed without exposing the inorganic particles on the surface of the layer and the particles do not easily transferred into the carrier liquid even contacting the carrier liquid, stable electric potential is attained, and further the blocking ability of the layer can be made uniform. And toner image having high density and high sharpness due to the characteristics of the liquid developer can be obtained

In the photoreceptor according to the invention, the intermediate layer is covered with the uppermost layer. The state of “the intermediate layer is covered with the uppermost layer” means that the uppermost layer is provided on or over the intermediate layer and the entire surface of the intermediate layer is substantially covered and exposed portion is substantially not left. It is allowed that the surface of the intermediate layer in the direction of the axis of substrate is substantially covered by the uppermost layer even when the edge of the intermediate layer and that of the uppermost layer are at an approximately the same position.

It is preferable that at least any one of middle layers provided between the intermediate layer and the uppermost layer is provided so that at least one of the middle layers covers the intermediate layer entirely if the uppermost layer does not cover the edges of the intermediate layer It is most preferable that entire surface of intermediate layer including the edges thereof in terms of the axis direction is covered with the uppermost layer irrespective of the presence of the middle layer.

The uppermost layer is the photosensitive layer or a protective layer. When the photosensitive layer is a multi-layered type, it is allowed that the intermediate layer is entirely covered with both or one of the charge generation layer and the charge transfer layer.

The invention is described below.

(Image Formation)

The image forming apparatus, image forming method and the processing cartridge to be employed in the invention are described below referring the drawings.

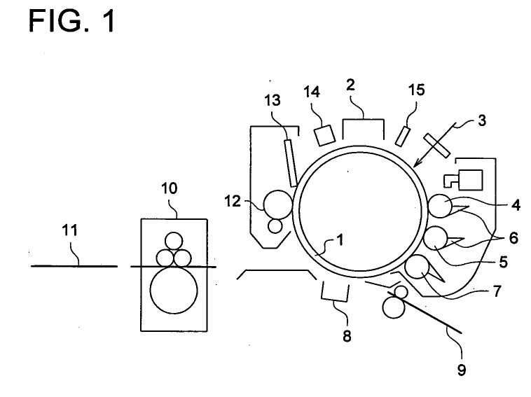

FIG. 1 shows a schematic cross section of an example of image forming apparatus in which an electrostatic latent image formed on a photoreceptor is developed as a toner image by a wet developing unit and the toner image is directly transferred onto a recording material.

In FIG. 1, 1 is a photoreceptor, 2 is a electrostatic charger, 3 is an imagewise exposing unit, 4 is a developing roller A, 5 is a developing roller B, 6 is a liquid developer, 7 is squeezing roller, 8 is a transferring charger, 9 is a fixing unit, 11 is a hard copy, 12 is a cleaning roller, 13 is a cleaning blade and 14 is a charge neutralizing lamp.

The photoreceptor 1 according to the invention is charged by the electrostatic charger 2 and then imagewise exposed by the exposing unit 3 to form an electrostatic latent image. The electrostatic latent image is developed by contacting to the liquid developer 6 through the developing roller A 4 and the developing roller B 5 in the developing unit to form a toner image. The excessive developer on the photoreceptor 1 is removed by the squeezing roller of the developing unit, and the toner image is transferred onto the recording material 9 such as paper by the transferring charger and made to the hardcopy 11 by passing the fixing unit 10 as a fixing unit. The developer remaining on the photoreceptor 1 is removed by the cleaning roller 12 and the cleaning blade 13 in the cleaning unit, and the remaining charge is removed by the charge removing lamp 14. Thus the apparatus proceeds to the next electrophotographying cycle.

The imagewise exposure by the imagewise exposing unit 3 may be either analogical imagewise exposure by irradiating the reflection light from an original image through a lens and a mirror or digital imagewise exposure by leading an original image by an image sensor such as a CCD, transferring to electric signals and reproducing as light signal by a light source such as a laser or a LED array.

The image forming method of the invention is preferably a method employing the foregoing image forming apparatus.

The processing cartridge according to the invention is composed of a combination of the photoreceptor and at least one of the charging unit, imagewise exposing unit, developing unit, transferring unit and cleaning unit, and is preferably constituted so as to be freely installed to and released from the main body of the image forming apparatus.

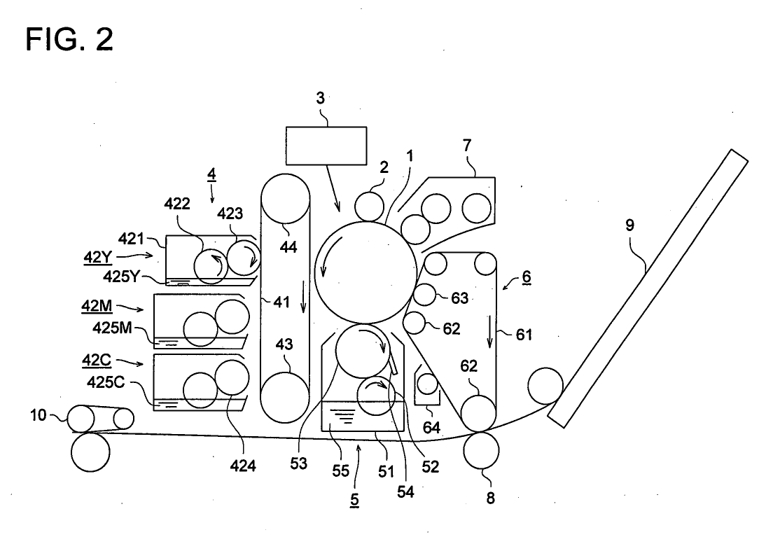

FIG. 2 shows a schematic cross section of an example of image forming apparatus in which an electrostatic latent image formed on a photoreceptor is developed to a toner image by a wet developing unit and the toner image is transferred onto a recording material trough an intermediate transfer unit using an intermediate transfer member.

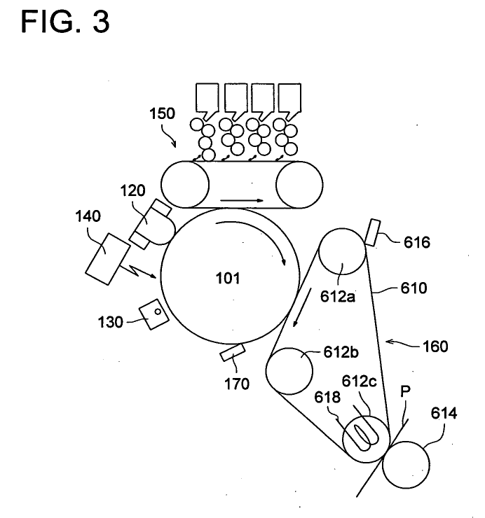

In FIG. 3, 1 is a photoreceptor, 2 is a charging unit, 3 is writing unit, 4 is a first developing unit, 5 is a second developing unit, 6 is an intermediate transferring unit, 7 is a cleaning unit, 8 is a transferring unit, 9 is a paper supplying unit and 10 is a fixing unit.

The recording material in the invention is a support for supporting the toner image, which is usually called as an image support, transferring material or transferring paper. In concrete, various kinds of recording material, for example, a ordinary paper from thin paper to cardboard, coated paper for printing such as art paper and coated paper, Japanese paper and post card paper available on the market, plastic film for OHP and cloth are employable, but the material is not limited to them.

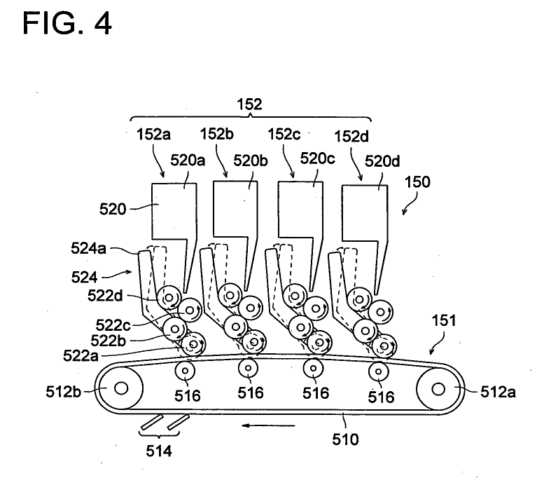

Another embodiment of the image forming apparatus according to the invention is described below. FIG. 3 shows a schematic drawing of the constitution of a liquid developing apparatus according to the invention. FIG. 4 shows the schematic front view of a developing unit to be employed in the liquid developing apparatus for developing an electrostatic latent image shown in FIG. 3.

As is shown in FIG. 3, the liquid image forming apparatus of the invention has a photoreceptor 101 as the image supporting member, a pre-wetting unit 120 for coating a pre-wetting liquid on the photoreceptor 101, a charging unit 130 for giving electric charge onto the photoreceptor 101, a exposing unit 140 for image exposing the photoreceptor 101 to light, a developing unit 150 for developing the electrostatic latent image by supplying the toner onto the portion where the electrostatic latent image is formed, a transferring unit 160 for transferring and fixing the toner on the photoreceptor 101 onto a designated recording paper P, a cleaning unit 170 for removing the toner remaining on the photoreceptor 101, and a charge neutralizing unit, not shown in the drawing, for removing the electrostatic charge on the photoreceptor 101.

Usual technology applied for usual electrophotographic printer can be applied in almost cases to the charging unit 130, exposing unit 140, cleaning unit 170 and electrostatic charge neutralizing unit.

The function required for the pre-wetting unit 120 is to uniformly coat the designated amount of the pre-wetting liquid. The simplest and suitable method is a method in which the pre-wetting liquid is coated by Belleater®, manufactured by Kanebo Co., Ltd.

The developing unit 150 is constituted by a developing means 151 and a coating means 152. The developing means 151 contains a developing belt 510 as a developer supporter, driving rollers 512a and 512b for driving, rounding and holding the developing belt 510 so as to contact a part of the developing belt 510 to the photoreceptor 101, a scraping blade 514 for removing the liquid developer remaining on the developing belt 510, and a supporting roller 516 as a pressing means. The coating means 152 contains coating units 152a, 152b, 152c and 152d for coating the liquid developer.

The developing means 152a through 152d contains a bellows pump 520 for storing and discharging the liquid developer, a coating roller 522a for coating the liquid developer onto the developing belt 510, carrying rollers 522b and 522c for carrying the liquid developer discharged from the bellows pump 520 to the coating roller 522a, and a contacting-releasing units 524 for contacting and releasing the coating roller 522a to/from the developing belt 510. The bellows pump 520a of the coating unit 152a, the bellows pump 520b of the coating unit 152b, the bellows pump 520c of the coating unit 152c and the bellows pump 520d of the coating unit 152d, each contains a liquid developer containing a yellow toner, that containing a magenta toner, that containing a cyan toner and that containing a black toner, respectively.

The coating roller 522a is arranged so as to contact with the carrying roller 522b, the carrying roller 522b is arranged so as to contact with the carrying roller 522c, and the carrying roller is arranged so as to contact with the controlling roller 522d. The coating roller 522a, the carrying roller 522b, the carrying roller 522c and the controlling roller 522d are each rounded in the direction according to the movement of the developing belt 510, the carrying roller 522a, the carrying roller 522b and the carrying roller 522c, respectively.

A hard roller having a hardness of not less than 60° (JIS A) is employed for the coating roller 522a and the carrying roller 522c, and a soft roller having a hardness of not more than 60° is employed for the carrying roller 522b and the controlling roller 522d.

The contacting-releasing unit has arms 524a and 524a. The coating roller 522a and carrying roller 522b are each fixed to the arms 524a and 524a, respectively. The arms 524a and 524a are each driven by a driving means, not shown in the drawing, so as to be rotated around the axis of the carrying roller 522b. The coating roller is contacted to or released from the developing belt by such the mechanism.

The developing belt 510 is driven by driving rollers 512a and 512b so as to be rotated in the direction in accordance with the motion of the photoreceptor 101. For the developing belt 510, a flexible belt such as a seamless nickel belt and a resin belt such as a polyimide belt. The developing belt 510 should be one to which developing bias can be applied. In the case of the resin belt, therefore, it is necessary to add an electroconductive fine particle for lowering the electric resistance or to apply an electroconductive treatment on the surface of the belt.

A supporting roller 516 is provided for supporting the coating roller 512a from the back side of the developing belt 510 on the occasion of the coating roller 522a is contacted to the developing roller 510, and is rotated in accordance with the developing belt 510. For the supporting roller 516, an elastic material such as sponge and felt. The coating roller 522a is pressed to the developing belt 510 with suitable pressure by the supporting roller of the elastic material.

The transfer unit 160 contains an intermediate transfer belt 610 as the transferring member, driving rollers 612a, 612b and 612c for rotationally driving the intermediate transfer belt 610 and holding the intermediate transfer belt 610 so as a part of the belt is contacted to the photoreceptor 101, a secondary transfer roller 614 provided so as to contacted to the secondary transfer belt 610, and a scraping blade 616 for removing the toner remaining on the intermediate transfer belt 610.

The intermediate transfer belt 610 is rotationally driven in the direction in accordance with motion of the photoreceptor by the driving rollers 612a, 812b and 612c. The secondary transfer roller 614 is pressed to the intermediate transfer roller 610 through paper P. A fixing heater 618 for heating the paper P is provided in the interior of the driving roller 612c.

(Layer Construction of Photoreceptor)

The photoreceptor according to the invention is characterized in that the intermediate layer containing inorganic particles having the specified particle diameter is covered with the uppermost layer.

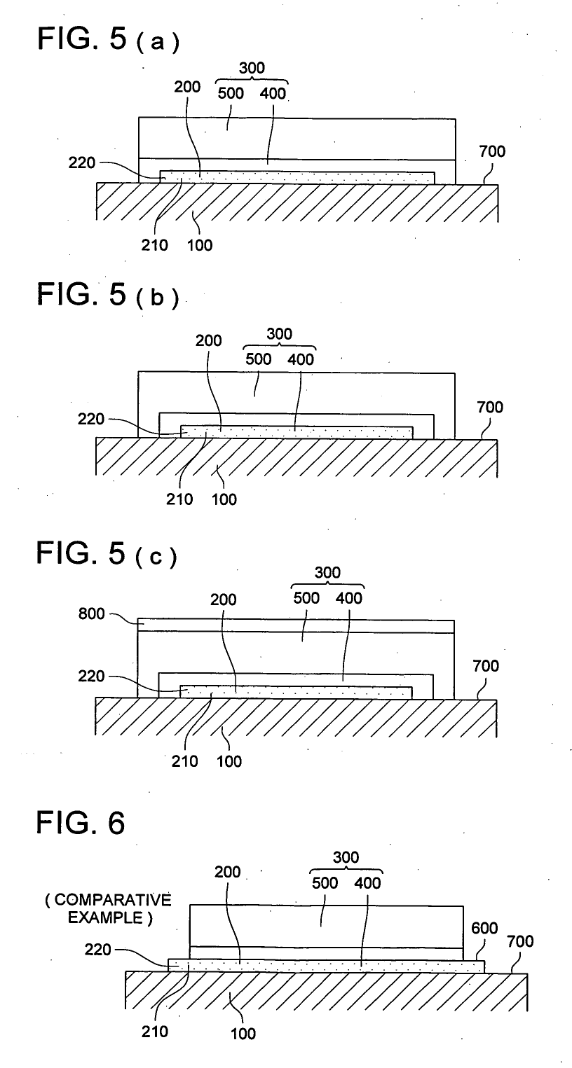

FIG. 5(a)-(c) are schematic drawings of examples of layer construction of a photoreceptor relating to the invention.

In FIGS. 5(a) to 5(c), 100 is the substrate, 200 is the intermediate layer, 210 is the inorganic particle, 220 is the binder, 300 is the photosensitive layer, 400 is the charge generation layer, 500 is the charge transfer layer, 700 is exposed portion of the substrate and 800 is the protective layer.

FIG. 5(a) is a schematic drawing of a layer construction in which the intermediate layer 200 is not reached at the end portion of the substrate 100 and the edge portion of the intermediate layer is covered with the photosensitive layer 300 and the exposing portion of the substrate 700 exists at the end portion of the substrate.

FIG. 5(b) is a schematic drawing of a layer construction in which the intermediate layer 200 is not reached at the end portion of the substrate 100 and the edge portion of the intermediate layer is covered with the charge generation layer 400, and the edge of the of the charge generation layer 400 is further covered with the charge transfer layer 500, and the charge transfer layer 500 is directly coated on the substrate at the edge portion of the layer, and the exposing portion of the substrate 700 exists at the end portion of the substrate.

FIG. 5(c) is a schematic drawing of a layer construction in which the protective layer 800 is provided as the uppermost layer on the charge transfer layer shown in FIG. 3b.

FIG. 6 is a schematic drawing of a comparative layer construction of the photoreceptor.

In FIG. 6, 600 is an exposing portion of the intermediate layer.

FIG. 6 (comparative example) shows a layer construction in which the intermediate layer 200 is not reached at the end portion of the substrate 100 and the edge portion of the intermediate layer is not covered with the photosensitive layer 300 and has an exposing portion 600, and the exposing portion of the substrate 700 exists at the end portion of the substrate.

The width of the exceeding width of the uppermost layer (the photosensitive layer or the protective layer) over the intermediate layer in the axis direction of the photoreceptor is preferably from 1 to 10 mm in one edge, and more preferably from 2 to 5 mm. The permeation of the developer until the intermediate layer containing the inorganic particles can be prevented by such the width of the uppermost layer exceeding over the intermediate layer.

The width of the exposing portion 700 where the substrate is exposed without any coating layer is not specifically limited and the layer may be coated until the end of the substrate.

The covering by the uppermost layer is particularly effective when the later-described surface treated inorganic particles are added to the intermediate layer for obtaining the high quality image by which lowering in the adhesiveness with the substrate and the peeling off is easily caused by the permeation of the developer.

(Inorganic Particle)

The inorganic particle to be used in the invention is one having a number-average primary particle diameter of from 5 to 300 nm, and preferably from 10 to 200 nm.

The number-average primary particle diameter is a value calculated by enlarging the particle image by 10,000 times by a transmission electron microscope and the image of 100 particles are randomly selected as the primary particles and subjected to the image analysis.

As the transmission electron microscope (TEM), H-9000NAR manufactured by Hitachi Seisakusho Co., Ltd. and JEM-200FX manufactured by Nihon Denshi Co., Ltd., can be exemplified.

The observation by the transmission electron microscope is performed by a method usually applied for measuring the diameter of a particle. For example, the following procedure is applied. First, a sample for observation is prepared as follows; the inorganic particles are sufficiently dispersed and embedded in epoxy resin and hardened to prepare a block. Then the block is sliced into a thin slice with a thickness of from 80 to 200 nm by a microtome having a diamond blade to prepare a sample for determination.

After that, the particles are photographed with a magnification of 10,000 by the transmission electron microscope. Then the image information of photographed 100 inorganic particles is operated to obtain the number-average of the diameter of the primary particles.

The inorganic particles having a number-average primary particle diameter within the foregoing range can be uniformly dispersed in the binder. Therefore, formation of coagulated particle or a large irregularity on the surface can be prevented so that a good toner image can be obtained, in which the occurrence of the black spots and the transferred memory caused by the coagulated particle affecting as an electron trap and the occurrence of the black spots caused by the large irregularity are prevented. Moreover, the inorganic particles are difficultly transferred into the intermediate layer coating liquid and the stability of the liquid is excellent.

The inorganic fine particle according to the invention is very small in the size and difficultly comes out to the surface layer. Therefore, the fine particle is not moved out into the carrier liquid if the carrier liquid is touched with the edge portion of the intermediate layer in the course of the repeating use. Consequently, the image forming system according to the invention is excellent in the inhibition in the image defect and in the charging stability.

The inorganic particle to be used in the invention is preferably an N-type semi-conductive particle.

Here, the N-type semi-conductive particle is a particle in which the charge carrier is an electron. Accordingly, the intermediate layer comprising an insulating resin and the N-type semi-conductive particles effectively blocks holes injected from the substrate and slightly blocks electrons from the photosensitive layer because the carrier in the particle is mainly electron.

A method for discriminating the N-type semi-conductive particle is described below.

An intermediate layer having a thickness of 5 μm is formed on a substrate (an electroconductive support) by the use of a dispersion composed of a resin constituting the intermediate layer and 50% by weight of the particles dispersed in the resin. The intermediate layer is negatively charged and the photo-attenuation of the charge is measured. Besides, the intermediate layer is positively charged and the photo-attenuation of the charge is also measured.

When the photo-attenuation of the negative charge is larger than that of the positive charge, the particle is discriminated as the N-type semi-conductive particle.

An inorganic oxide is preferable for the inorganic particle. In concrete, a metal oxide such as titanium oxide (TiO₂), zinc oxide (ZnO₂), tin oxide (TiO₂) is preferable, and titanium oxide is particularly preferable.

The crystal shape of titanium oxide includes anatase type, rutile type, brookite type and amorphous type. Among them, anatase type titanium oxide is preferable for the inorganic particle relating to the invention, by which commutating effect to the electric current passing the intermediate layer is raised the mobility of electron is raised, the charging potential is stabilized, the increasing in the remaining charge is inhibited and the occurrence of the transfer memory can be prevented.

The inorganic particle may be treated by a surface treating agent. The surface treated inorganic particle is improved in the dispersing ability so that the uniform intermediate layer can be formed by such the particle.

For the surface treatment, a method is applicable, in which a reactive group existing on the surface of the inorganic particle such as a hydroxyl group is reacted with a coupling agent. As the coupling agent, a silane coupling agent, a titanium coupling agent and an aluminum coupling agent are preferable. The following titanium coupling agent are employable; isopropyl triisostearoyltitanate, isopropyl tris(dioctylpyrophosphate)titanate, isopropyl tri(N-aminoethylaminoethyl)titanate, tetraoctyl bis(di-tridecylphosphite)titanate, tetra(2,2-diallyloxymethyl-1-butyl(bis)di-tridecyl)phosphate-titanate, bis(dioctylpyrophosphate)oxyacetate-titanate, bis(dioctylpyrophosphate)ethylenetitanate, isopropyl trioctanoyltitanate, isopropyl dimethacrylisostearoyltitanate, isopropyl tridodecylbenzenesulfonyltitanate, isopropyl isostearoyldiacryl-titanate, isopropyl tri(dioctyl phosphate)titanate, isopropyl triacylphenyltitanate and tetraisopropyl bis(dioctylphosphite)titanate.

As the aluminum coupling agent, acetoalkoxyaluminum diisopropylate is employable.

As the silane coupling agent the followings are employable; vinyltrichlorosilane, vinyltris(β-methoxy-ethoxy)silane, vinyltriethoxysilane, vinyltrimethoxysilane, γ-methacryloxypropyltriethoxysilane, β-(3,4-epoxycyclohexyl)-ethyltrimethoxysilane, γ-glycidoxy-propyl-trimethoxysilane, γ-glycidoxypropylmethyldiethoxysilane, N-β-(aminoethyl)γ-aminopropyltrimethoxysilane, N-β-(aminoethyl) γ-aminopropylmethyldimethoxysilane, N-phenyl-γ-aminopropylmethoxysilane, γ-mercaptopropyl-trimethoxysilane and γ-chloropropyltrimethoxysilane.

In the case of the titanium oxide, a surface treatment (primary treatment) by at least one of alumina, silica and zirconia is preferably applied before the above-described surface treatment. The treatment by alumina, silica or zirconia is a treatment for depositing alumina, silica or zirconia onto the surface of the titanium oxide particle, and the alumina, silica and zirconia each may include a hydrated compound thereof.

The surface treatment of the titanium oxide by the metal oxide such as alumina, silica and zirconia can be carried out by the following procedure. Titanium oxide particles having a number-average primary particle diameter of 50 nm is dispersed in water in a concentration of from 50 to 350 g/L to prepare an aqueous slurry, and a water-soluble silicate or a water-soluble aluminum compound is added to the slurry. After that, an alkali or an acid is added for neutralizing the slurry to precipitate silica or alumina onto the surface of the titanium oxide particles. The titanium oxide particles are filtered, washed and dried to obtain surface treated titanium oxide particles. When sodium silicate is used as the water-soluble silicate, the neutralization can be carried out by an acid such as sulfuric acid, nitric acid and hydrochloric acid. Besides, when aluminum sulfate is employed as the water-soluble aluminum compound, the neutralization can be carried out by an alkali such as sodium hydroxide and potassium hydroxide.

As above-described, the surface treatment on the titanium oxide particles can be uniformly performed by at least two times of treatment by the above primary treatment and the secondary treatment the coupling agent for treating the reactive group after the primary treatment. Thus treated titanium oxide particles are suitable in the dispersing ability and the good photoreceptor without occurrence of image defects such as the black spots can be obtained.

It is particularly preferable that the treatment by alumina is firstly performed and then the treatment by silica is carried out though the treatments by alumina and silica may be carried out simultaneously. When the treatments by alumina and silica are separately performed, the treatment amount of silica is preferably larger than that of alumina.

The amount of the metal oxide for the surface treatment is preferably from 0.1 to 50 parts, and more preferably from 1 to 10 parts, by weight per 100 parts by weight of the titanium oxide particles in the charging amount on the occasion of the surface treatment.

(Preparation of Photoreceptor)

The photoreceptor in which the intermediate layer is covered with the uppermost layer can be prepared, for example, by coating the layer by an immersion coating method while controlling the immersing depth, a circular coating amount regulation coating method or a combination the above methods, and removing unnecessary portion of the coated layer. But the preparation method is not limited to the above. The circular coating amount regulation coating method is described in Tokkai Sho 58-189061, for example.

In the immersion coating, the edge position of the coated layer easily can be controlled on one end of the substrate by controlling the immersing depth so that the edge of the intermediate layer is positioned beyond that of the other layer or the edge of the charge generation layer or the charge transfer layer is positioned beyond that of the intermediate layer.

On the other end of the substrate, the layer is coated almost until the end of the substrate by the immersion coating. For covering the intermediate layer, therefore, unnecessary portion of the intermediate layer is removed by a solvent capable of dissolving or swelling the intermediate layer, and then the charge generation layer and the charge transfer layer are coated. After that unnecessary potion of the charge generation layer and the charge transfer layer are removed by a solvent capable of dissolving or swelling these layers.

A preparation method of a photoreceptor having the structure shown in FIG. 5(b) is described in detail below.

Step 1: An intermediate layer coating liquid is coated until a line apart by 15 mm from the upper end of the substrate by controlling the immersing depth in the immersion coating method and dried to form an intermediate layer.

Step 2: The intermediate layer coated at the lower end portion of the substrate is removed in a width of 15 mm from the lower end of the substrate by a tape impregnated by a solvent capable of dissolving or swelling the intermediate layer.

Step 3: A charge generation layer coating liquid is coated until a line apart by 13 mm from the upper end of the substrate by controlling the immersing depth in the immersion coating method and dried to form a charge generation layer.

Step 4: The charge generation layer coated at the lower end of the substrate is removed in a width of 13 mm from the lower end of the substrate by a tape impregnated by a solvent capable of dissolving or swelling the charge generation layer.

Step 5: A charge transfer layer coating liquid is coated until a line apart by 10 mm from the upper end of the substrate by controlling the immersing depth in the immersion coating method and dried to form a charge transfer layer.

Step 6: The charge transfer layer coated at the lower end of the substrate is removed in a width of 10 mm from the lower end portion of the substrate by a tape impregnated by a solvent capable of dissolving or swelling the charge transfer layer to finish the coating layer formation of the photoreceptor.

The parts and the layers constituting the photoreceptor relating to then invention are described below.

(Substrate)

A cylindrical or belt type substrate having a specific resistance of not more than 10³ Ωcm is preferable. As concrete example, an aluminum cylinder cleaned on the surface after cutting and shaving can be cited.

(Intermediate Layer)

The intermediate layer is formed by coating and dried an intermediate layer coating liquid comprising the inorganic particle, binder and dispersing medium.

In the intermediate layer, the volume of the inorganic particles is preferably from 0.5 to 2.0 times of that of the binder. By the presence of the inorganic particles within such the volume ratio, the rectifying ability of the intermediate layer is increased and the raising in the remaining potential and the occurrence of transfer memory are prevented, and the occurrence of black spot can be effectively prevented, so as to form a suitable photoreceptor with small potential fluctuation.

In concrete, it is preferable that the intermediate layer contains from 50 to 200 parts by volume of the inorganic particles to 100 parts by volume of the binder resin.

As the binder for dispersing the inorganic particles, polyamide resin, vinyl chloride resin, vinyl acetate resin and a copolymer resin containing two or more repeating units in the above resins are usable. Among the above resins, the polyamide resin is preferable, by which rising in the remaining potential accompanied with the repeating use can be inhibited. A polyamide having a repeating unit represented by the following Formula 1 is more preferable.

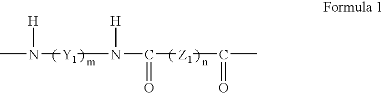

In Formula 1, Y₁ is a divalent group containing a cycloalkane substituted by an alkyl group, Z₁ is a methylene group, m is an integer of from 1 to 3 and n is an integer of from 3 to 20.

In the above Formula 1, the divalent group containing a cycloalkane group substituted by an alkyl group is preferably one having the following chemical structure. The polyamide resin in which Y₁ is a group represented by the following structure is small in the variation in the anti-charge-blocking ability depending on temperature variation and shows considerable black spot improving effect.

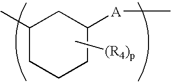

In the above structure, A is a single bond or an alkylene group having 1 to 4 carbon atoms, R₄ is an alkyl group, and p is a natural number of from 1 to 5, and the plural R₄s may be the same or different from each other.

Concrete examples of the polyamide resin relating to the invention are listed below.

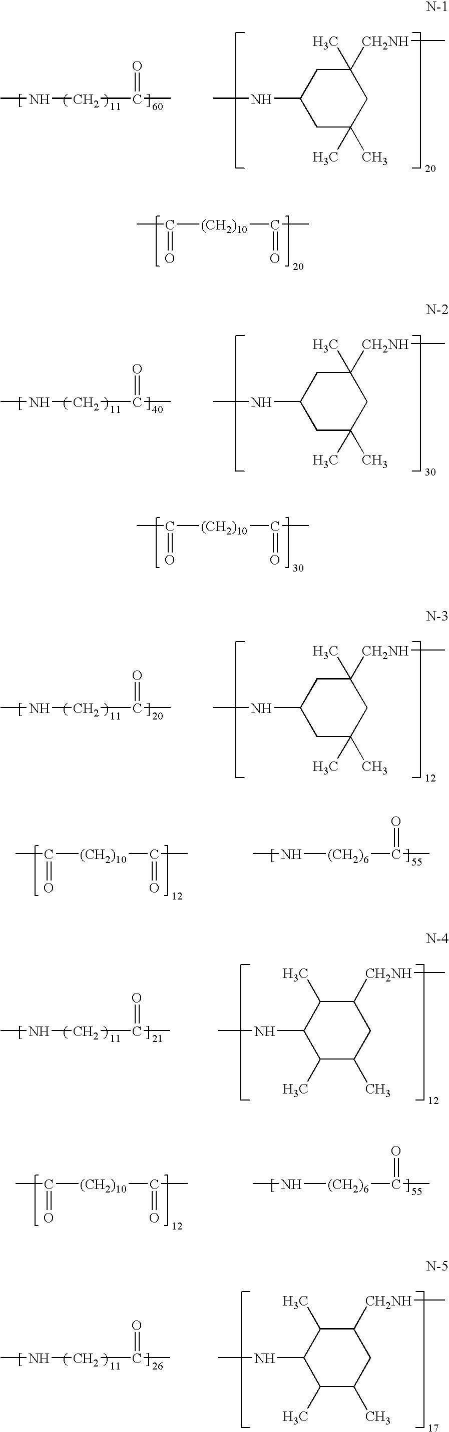

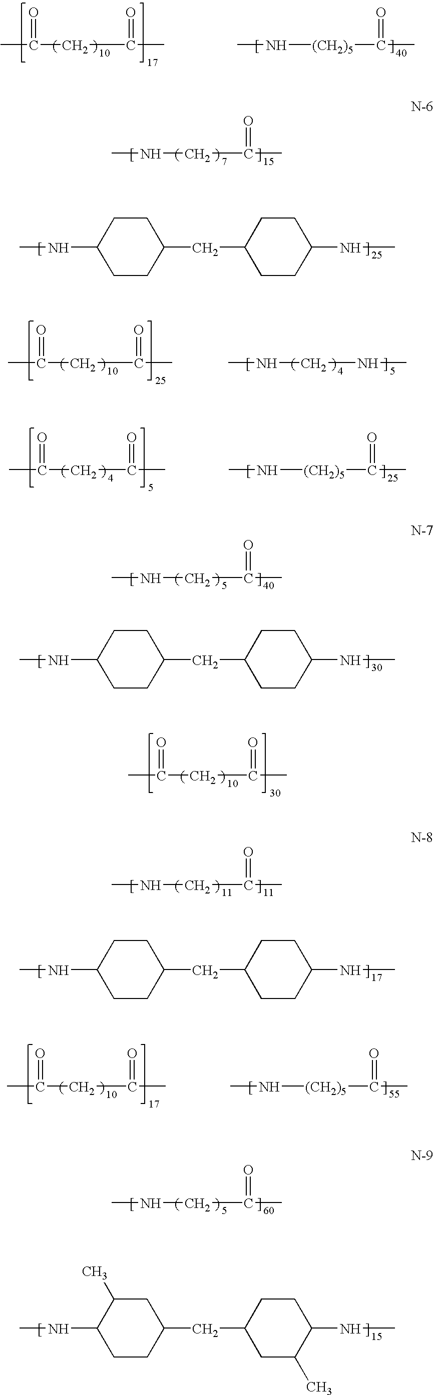

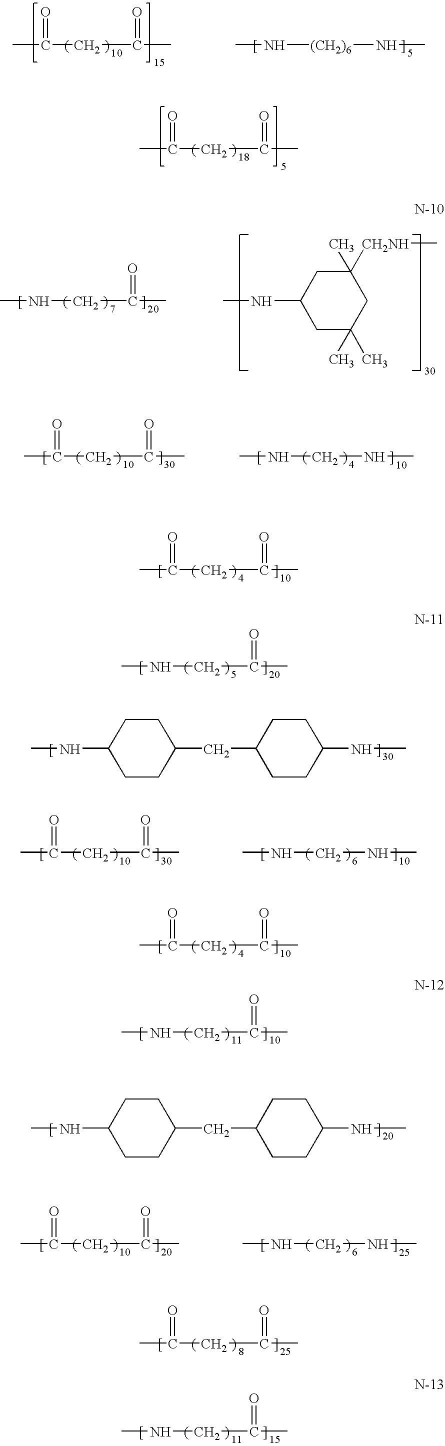

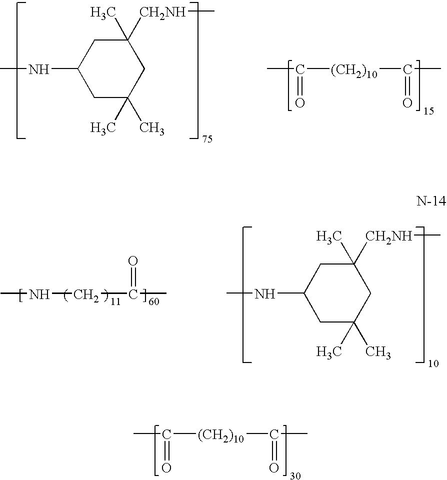

Among the examples, the polyamides N-2 to N-5, N-9, N-10, and N-14 are particularly preferable, which has the repeating unit containing the cycloalkane group substituted by an alkyl group represented by Formula 1.

The molecular weight of the polyamide resin is preferably from 5,000 to 80,000, and more preferably from 10,000 to 60,000 in the number-average molecular weight. The thickness of the intermediate layer can be uniform, the occurrence of coagulum of the resin can be prevented and the occurrence of the image defects such as black spots can be also prevented by making the number-average molecular weight of the resin into such the range.

As the solvent for preparing the intermediate layer coating liquid, one capable of finely dispersing the inorganic particles and dissolving the polyamide resin is preferable. In concrete, an alcohol having 2 to 4 carbon atoms such as ethanol, n-propyl alcohol, isopropyl alcohol, n-butanol, t-butanol and sec-butanol is preferable since it is excellent in the dissolving ability to the polyamide resin and the coating suitability. It is preferable that such the solvent occupies from 30 to 100%, preferably from 40 to 100%, and more preferably from 50 to 100%, by weight of the entire solvent. As an assistance solvent to be employed together with the above solvent, methanol, benzyl alcohol, toluene, methylene chloride, cyclohexanone and tetrahydrofuran, for example, are suitable for obtaining a preferable effect.

The thickness of the intermediate layer according to the invention is preferably from 0.2 to 40 μm, and more preferably from 0.3 to 20 μm. By making the thickness into the above range, occurrence of the black spot can be inhibited, increasing in the remaining potential and the transfer memory are difficultly caused, the toner adhering onto the exposed portion of the intermediate layer can be successfully cleared, and a toner image with high sharpness can be obtained.

The intermediate layer according to the invention is substantially an electrically isolative layer. Here, the isolative layer is a layer having a volume resistance of not less than 1×10³ Ω·cm. The volume resistance of the intermediate layer of the invention is preferably from 1×10⁸ to 1×10¹⁵ Ω·cm, more preferably from 1×10⁹ to 1×10¹⁴ Ω·cm, and further preferably from 1×10⁹ to 1×10³ Ω·cm. The volume resistance can be measured as follows.

Measuring condition: According to JIS C2318-1975
Measuring apparatus: Hiresta IP

(Mitsubishi Yuka Co., LTD.)
Measuring condition: Measuring prove HRS
Applying voltage: 500 V
Measuring environment: 20±2° C., 65±5% RH

(Photosensitive Layer)

The photosensitive layer is preferably one having a layer structure in which the functions of the layer is separated into the charge generation layer (CGL) and the charge transfer layer (CTL), though a single layer structure is arrowed, in which both of the functions are charged to one layer. By the function separated layer structure, the increasing in the remaining potential caused by the repeating use can be controlled to small and the photographic propertied can be easily controlled for fitting to the purpose. In the negatively charging photoreceptor, the charge generation layer (CGL) is provided on the intermediate layer and the charge transfer layer is provided on the charge generation layer. In the positively charging photoreceptor, the charge generation layer and the charge transfer layer are arranged in reverse order. The preferable layer structure of the photoreceptor is the negatively charging photoreceptor having the foregoing function separated structure.

Layers of the function separated negatively charging charge generation layer are each described below.

<Charge Generation Layer>

The charge generation layer contains a charge generation material (CGM). Additionally to the charge generation layer, a binder resin and an additive may be contained.

As the charge generation material (CGM), known charge generation materials can be employed. For example, a phthalocyanine pigment, an azo pigment, a perylene pigment and an azulenium pigment are employable. Among them, the CGM by which the increasing remaining potential caused by the repeating use can be made to minimum is one having a steric and potential structure capable of taking a stable coagulated structure by plural molecules thereof. In concrete, a phthalocyanine pigment or a perylene pigment each having a specific crystal structure can be exemplified. A titanyl-phthalocyanine having the highest peak at 27.2° of Bragg angle 2θ and a benzimidazoleperylene having the highest peak at 12.4° of Bragg angle 2θ in the diffraction spectrum of Cu-Ka characteristic X-ray, for example, cause almost no degradation accompanied with repeating use and can inhibit the increasing in the remaining potential.

When a binder is used as the dispersing medium for the CGM in the charge generation layer, known binders can be applied. The most preferable resin includes a formal resin, a butyral resin, a silicone resin, a silicone-modified butyral resin and a phenoxy resin. The ratio of the charge generation material to the binder resin is preferably from 20 to 600 parts by weight per 100 parts of the binder resin. The increasing in the remaining potential caused by repeating use can be inhibited by the use of such the resins. The thickness of the charge generation layer is preferably from 0.01 to 2 μm.

<Charge Transfer Layer>

The charge transfer layer contains a charge transfer material (CTM) and a binder resin for dispersing the CTM and forming a film. Another additive such as an antioxidant may be further contained.

As the charge transfer material, known charge transfer materials can be employed. A triphenylamine derivative, a hydrazone compound, a styryl compound a benzidine compound and a butadiene compound, for example, can be employed. These charge transfer materials are usually dissolved in a suitable binder to form a layer. Among them, the CTM capable of minimizing the increasing in the remaining potential caused by repeating use is one having high mobility and a difference in the ionizing potential between the CGM to be used in combination of not more than 0.5 (eV), preferably not more than 0.25 (eV).

The ionizing potential of the CGM and that of the CTM can be measured by a surface analyzing apparatus AC-1, manufactured by Riken Keiki Co., Ltd.

A polystyrene resin, an acryl resin, a methacryl resin, a vinyl chloride resin, a vinyl acetate resin, a poly(vinyl butyral) resin, an epoxy resin, a polyurethane resin, a phenol resin, a polyester resin, an alkyd resin, a polycarbonate resin, a silicone resin, a melamine resin and a copolymer containing two or more repeating units of the above-described resins, for example, can be employed for the binder resin of the charge transfer layer (CTL). Other than the above electric insulating resin, an organic polymer semiconductor such as poly-N-vinylcarbazole is applicable.

Among them, the polycarbonate rein is most preferable for the binder of CTL. The polycarbonate resin is most preferable because it is suitable in the dispersing ability to the CTM and improves electrophotographic properties. The ratio of the charge transfer material to the binder of preferably from 10 to 200 parts by weight of the CTM per 100 parts by weight of the binder resin. The thickness of the charge transfer layer is preferable from 10 to 40 μm.

As the antioxidant, known compounds can be applied. In concrete, IRGANOX 1010, manufactured by Nihon Ciba-Geigy Co., Ltd., can be cited.

In the photoreceptor of the invention, an electro conductive layer may be provided between the substrate and the intermediate layer and a protective layer may be provided on the charge transfer layer according to necessity.

The electroconductive layer and the protective layer are described below.

<Electroconductive Layer>

When laser light is employed for imagewise exposure, the electroconductive layer is preferably provided between the intermediate layer and the cylindrical substrate for preventing occurrence of interference fringes. The electroconductive layer can be formed by coating and dried a liquid comprising a binder resin and an electroconductive inorganic particle such as carbon black and a metal particle dispersed in the binder resin on the intermediate layer. The thickness of the electroconductive layer is preferably from 5 to 40 μm, and more preferably from 5 to 30 μm.

<Protective Layer>

The protective layer can be provided on the photosensitive layer for improving the surface condition of the photoreceptor. The use of a resin or a hardenable resin each having anti-abrasion ability for the protective layer is preferably for raising the anti-abrasion ability and the surface hardness. The hardenable resin is usually employed for the binder resin of the protective layer because the variation of resistivity of the protective layer depending on the environmental conditions can be made small by such the resin and the resin is superior in the stability of the dispersion. As the resin of the protective layer, a polycarbonate resin, an acryl resin, a phenol resin, an epoxy resin, a urethane resin and a siloxane resin are employable.

(Developer)

The developer containing the toner is a liquid developer.

The liquid developer includes a carrier liquid comprising such as an aliphatic hydrocarbon compound, higher fatty acid ester, vegetable oil and silicone oil, a toner comprising a resin and a colorant dispersed in the carrier liquid.

A non-aqueous solvent having high isolating ability and low permittivity such as trichlorotrifluoroethane, hexane, cyclohexane, ISOPER H, liquid paraffin, and silicone oil are employed for the carrier liquid.

Examples of the liquid paraffin include CRYSTOL J-52, CRYSTOL J-72, CRYSTOL J-102, CRYSTOL J-142, CRYSTOL J-142, CRYSTOL J-172, CRYSTOL J-202, CRYSTOL J-262, CRYSTOL J-322, CRYSTOL J-352, ESSO WHITE OIL M-52, ESSO WHITE OIL M-72, ESSO WHITE OIL M-82, ESSO WHITE OIL M-172 and ESSO WHITE OIL M-351, each manufactured by Esso Petroleum Co., Ltd. Examples of the silicone oil include KF96 manufactured by Shin'etsu Silicone Co., Ltd., SH344, manufactured by Toray Silicone. Co., Ltd., TSF451 series, TSF404 (cyclic dimethyl polysiloxane) and TFS4704 (amino-modified silicone), each manufactured by Toshiba Silicone Co., Ltd., and SH200-50 (chain dimethylsilicone), and DC345 (cyclic silicone), each manufactured by Toray•DowCorning Co., Ltd. It is preferable in the invention to mainly employ silicone oil and to mix with liquid paraffin for improving the dispersing ability. The mixing ratio in weight of the liquid paraffin to the silicone oil is from 0 to 50% by weight and 50 to 100% by weight of the silicone oil.

An alkyd resin, a rosin-modified phenol-formaldehyde resin, a poly-valent alcohol ester of hydrogenated rosin, a polyacrylate resin, a polymethacrylate resin, a styrene resin and chloride rubber are employed for the toner.

As the colorant, carbon black, Phthalocyanine Blue, Phthalocyanine Green, Sky Blue, Rhodamine Lake, Malachite Green Lake, Methyl Violet Lake, Peacock Blue Lake, Naphthol Green B, Naphthol Green Y, Naphthol Yellow S, Resol Fast Yellow 2G, Permanent Red 4R, Brilliant Fast Scarlet, Hansa Yellow, Benzidine Yellow, Resol Red, Lake Red, Lake Red D, Brilliant Carmine 6B, Permanent Red F5R, Pigment Scarlet 3B, Bordeaux 10B and naphthol Red are usable, for example.

The liquid developer of the invention can be obtained by charging the colorant, resin carrier liquid and charge controlling agent into a dispersing machine such as a ball mill a kitty mill, a disc mill and a pin mill, and dispersing and kneading to prepare a concentrated toner, and then dispersing the concentrated toner into the carrier liquid.

The viscosity of the liquid developer is decided according to the carrier liquid, the resin colorant, the charge controlling agent and the concentrations of them. The viscosity of the liquid developer of the invention is preferably from 100 to 10,000 mPa·s measured at 23° C. by a B-type viscometer. The high viscous liquid developer has an advantage that the amount of the carrier liquid contained in the liquid developer can be made very small since such the liquid developer is formed on the developing roller in a shape of thin layer. Therefore, the amount of the carrier liquid contained in the liquid developer supplied to the photoreceptor becomes very small. Consequently, the amount of the carrier liquid absorbed in the paper on the occasion of transfer becomes extremely small. The carrier liquid remaining after the fixing is almost not observed when the viscosity of the developer is not less than 1,000 mPa·s.

When the viscosity is within such the range, the coating ability of the liquid developer onto the developing roller and the coating belt is good so that an image superior in the high density and the uniformity of solid image can be obtained.

The viscosity value in the invention is measured by an E-type viscometer at 20° C. and a slipping rate of 1 sec⁻¹.

The average particle diameter of the liquid developer of the invention is preferably from 0.1 to 5 μm, and more preferably from 0.3 to 4.0 μm, for forming an image superior in high density, the uniformity of solid image and the resolution. When the average particle diameter is less than 0.1 μm, sufficient density cannot be obtained sometimes, and an average diameter of more than 5 μm causes lowering in the resolution sometimes.

In the liquid developer of the invention, the content of the toner particles in the entire developer, namely the content of the resin and the colorant in the liquid developer, is preferably from 5 to 50% by weight, and more preferably from 10 to 45% by weight, for forming an image superior in the image density and the uniformity of solid image. Sufficient density cannot be obtained when the content is less than 5% by weight, and a problem of the supplying of the developer is caused.

### EXAMPLES

Examples of the invention are described below, but the invention is not limited to the examples.

### Examples 1 TO 9

(Preparation of Photoreceptor)<

Preparation of Photoreceptor 1>

Substrate:

A cylindrical aluminum substrate was employed as the substrate, the surface of which was finished to the ten-point surface roughness Rz of 0.8a μm according to JIS B 0601 by shaving treatment and cleaned by washing.

Formation of intermediate layer:

A liquid of the mixture of the following components was dispersed for 10 hours by a batch method using a sand mill dispersing machine. The resultant dispersion was diluted by 2 times by a mixture of the same solvents and stood for one night, and then filtered through Rigimesh, manufactured by Nihon Pall Corp., having a nominal filtering accuracy of 5 μm while applying a pressure of 50 kPa to prepare an intermediate layer coating liquid.

Intermediate layer coating liquid;

| | | |
|---|---|---|
| Polyamide resin represented by | 1.0 | part by weight |
| chemical formula N-9 | (1.0 | part by volume) |
| Rutile type titanium oxide | 3.5 | parts by weight |
| (number-average primary particle | (1.0 | part by volume) |
| diameter: 33 nm) | | |
| Solvent (ethanol/n-propyl | 10.0 | parts by weight |
| alcohol/tetrahydrofuran = | | |
| 5/2/3 in weight ratio) | | |

The above intermediate layer coating liquid was coated until the line apart 15 mm from the upper end of the substrate and dried to form an intermediate layer by controlling the immersion depth.

After that, 15 mm width of the intermediate layer from the lower end of the substrate was removed by a tape impregnated by the solvent, a mixture of ethanol/n-propyl alcohol/tetrahydrofuran in a weight ratio of 5/2/3, for exposing the surface of the lower end portion of the substrate, and then the coated layer was heated at 120° C. for 30 minutes to form an intermediate layer having a thickness of 3.0 μm. The layer thickness is a value measured by an eddy electric current type layer thickness measuring apparatus EDDY560C manufactured by Helmut Fischer CMBTE Co.

Preparation of charge generation layer:

A mixture liquid of the following components was dispersed by a sand mill dispersing machine to prepare a charge generation layer coating liquid.

Charge generation layer coating liquid;

| | |
|---|---|
| Y type oxytitanylphthalocyanine (a | 20 parts by weight |
| titanylphthalocyanine having the | |
| highest peak at a Bragg angle (2θ ± 0.2°) | |
| of 27.3° in a diffraction spectrum | |
| by Cu—Kα characteristic X-ray | |
| Silicone-modified poly(vinyl butyral) | 10 parts by weight |
| 4-methoxy-4-methyl-2-pentanone | 700 parts by weight |
| t-butyl acetate | 300 parts by weight |

The above coating liquid was coated until the line apart 13 mm from the upper end of the substrate and dried to form a charge generation layer by controlling the immersion depth.

After that, 13 mm width of the charge generation layer from the lower end of the substrate was removed by a tape impregnated by the solvent, a mixture of 4-methoxy-4-methyl-2-pentanone and t-butyl acetate in a weight ratio of 7/3, for exposing the surface of the lower end portion of the substrate. Thus a charge generation layer having a thickness of 0.3 μm was formed on the intermediate layer. The layer thickness is a value measured by an eddy electric current type layer thickness measuring apparatus EDDY560C manufactured by Helmut Fischer CMBTE Co.

Formation of charge transfer layer:

The following components were dissolved to prepare a charge transfer layer coating liquid.

Charge transfer layer coating liquid;

| | |
|---|---|
| 4-methoxy-4′-(4-methyl-α- | 70 parts by weight |
| phenylstyryl)triphenylamine | |
| Bisphenol Z type polycarbonate, | 100 parts by weight |
| Iupilon Z300 (Mitsubishi | |
| Gas Kagaku CO., Ltd.) | |
| Antioxidant Irganox 1010 (Nihon | 8 parts by weight |
| Ciba-Geigy Co., Ltd.) | |
| Solvent (tetrahydrofuran/toluene = | 750 parts by weight |
| 8/2 in weight ratio) | |

The above coating liquid was coated until the line apart 10 mm from the upper end of the substrate and dried to form a charge transfer layer by controlling the immersion depth.

After that, 10 mm width of the charge transfer layer from the lower end of the substrate was removed by a tape impregnated by the solvent, a mixture of tetrahydrofuran and toluene in a weight ratio of 8/2, for exposing the surface of the lower end portion of the substrate. Thus a charge transfer layer having a thickness of 25 μm was formed on the charge generation layer. Thus Photoreceptor 1 corresponding to FIG. 6(b) was obtained. The layer thickness is a value measured by an eddy electric current type layer thickness measuring apparatus EDDY560C manufactured by Helmut Fischer CMBTE Co.

<Preparation of Photoreceptors 2 through 7, 10 and 11>

Photoreceptors 2 through 7, 10 and 11 each corresponding to FIG. 6(b) were prepared in the same manner as in Photoreceptor 1 except that the inorganic particle employed in the intermediate layer was changed as shown in Table 2, and 13 mm width of the charge transfer layer was removed from the both ends of the substrate by a tape impregnated by the solvent, a mixture of t-butyl acetate and tetrahydrofuran in a weight ratio of 5/5, so that the edges of the charge generation layer and the charge transfer layer are positioned at almost the same position.

<Preparation of Photoreceptor 8>

Formation of protective layer:

A mixture of the following components was dissolved to prepare a protective layer coating liquid.

Protective layer coating liquid;

| | |
|---|---|
| 4-methoxy-4′-(4-methyl-α- | 70 parts by weight |
| phenylstyryl)triphenylamine | |
| Bisphenol Z type polycarbonate, | 100 parts by weight |
| Iupilon Z800 (Mitsubishi | |
| Gas Kagaku Co., Ltd.) | |
| Antioxidant, Irganox 1010 (Nihon | 8 parts by weight |
| Ciba-Geigy Co., Ltd.) | |
| Solvent (tetrahydrofuran/toluene = | 750 parts by weight |
| 8/2 in weight ratio) | |

The above protective layer coating liquid was coated on the surface of Photoreceptor 1 by a circular coating amount regulating coating apparatus and dried to form a protective layer with a thickness of 3 μm.

Then 8 mm width of the charge transfer layer was removed from the both ends of the substrate by a tape impregnated by the solvent, a mixture of tetrahydrofuran and toluene in a weight ratio of 8/2, to prepare Photoreceptor 7 corresponding to FIG. 5(c). The layer thickness is a value measured by an eddy electric current type layer thickness measuring apparatus EDDY560C manufactured by Helmut Fischer CMBTE Co.

<Preparation of Photoreceptor 9>

The charge transfer layer of a photoreceptor the same as Photoreceptor 1 was further removed in a width of 3 mm from each of the both ends of the substrate by the tape impregnated by the solvent, a mixture of tetrahydrofuran and toluene in a weight ratio of 8/2, to expose the end portions of the substrate. Thud photoreceptor 9 corresponding to FIG. 5(a) was prepared, in which the edges of the charge generation layer and the charge transfer layer were positioned at almost the same position.

<Preparation of Photoreceptor 12>

Photoreceptor 12 corresponding to FIG. 5(b) was prepared in the same manner as in Photoreceptor 1 except that the inorganic particle used in Photoreceptor 1 was omitted.

<Preparation of Photoreceptor 13>

Photoreceptor 13 corresponding to FIG. 6 was prepared by removing the photosensitive layer (the charge generation layer and the charge transfer layer) on a photoreceptor the same as Photoreceptor 4 were removed in the width of 20 mm from each of the ends of the photoreceptor by the tape impregnated by the solvent composed of t-butyl acetate and tetrahydrofuran in a weight ratio of 5/5. In the photoreceptor 13 the intermediate layer is exposed by 5 mm from the edge of the photosensitive layer.

The inorganic particles and the number-average primary particle diameter thereof, and the layer construction in each of Photoreceptors 1 through 13 are listed in Table 1.

TABLE 1

| | Intermediate layer | | | | |
|---|---|---|---|---|---|
| | | Number- | | | |
| | | average | | | |
| | | primary | | | |
| Photo- | | particle | Photo- | | |
| receptor | Inorganic | diameter | sensitive | Protective | Layer |
| No. | particle | (nm) | lay | layer | construction |
| 1 | *2 | 33 | Coated | | FIG. 5(b) |
| 2 | *2 | 7 | Coated | | FIG. 5(b) |
| 3 | Anatase | 290 | Coated | | FIG. 5(b) |
| | type | | | | |
| | titanium | | | | |
| | oxide | | | | |
| 4 | Surface | 35 | Coated | | FIG. 5(b) |
| | treated | | | | |
| | titanium | | | | |
| | oxide *1 | | | | |
| 5 | Zinc | 50 | Coated | | FIG. 5(b) |
| | oxide | | | | |
| 6 | *2 | 12 | Coated | | FIG. 5(b) |
| 7 | *2 | 190 | Coated | | FIG. 5(b) |
| 8 | *2 | 33 | Coated | Coated | FIG. 5(c) |
| 9 | *2 | 33 | Coated | | FIG. 5(a) |
| 10 | *2 | 310 | Coated | | FIG. 5(b) |
| 11 | *2 | 3 | Coated | | FIG. 5(b) |
| 12 | — | | Coated | | FIG. 5(b) |
| 13 | Surface | 35 | Coated | | |
| | treated | | | | |
| | titanium | | | | |
| | oxide *1 | | | | |

*1: Titanium oxide treated by a copolymer of methylhydrogensilixane and dimethylsiloxane in a mole ratio of 1:1 in an amount of 5% by weight of entire amount of the titanium oxide
*2: Rutile type titanium oxide

[Evaluation]

A wet developing type copying machine RICOPY CT-5085, manufactured by Ricoh Co., Ltd., was employed for evaluating the photoreceptors. The copy machine was modified, so that the polarity of charging was changed from positively charging to negatively charging and the optical system was changed to a digital system.

As the developer, a liquid developer Developer Type 5085 using an aliphatic hydrocarbon was employed.

The above-prepared photoreceptors were each successively installed into the image forming apparatus for forming images.

<Visual Observation>

Peeling of coated layer at edge portion:

After printing of 100,000 sheets, the photoreceptor was unloaded from the image forming apparatus and the situation of the coated layer at the edge portion was visually observed for evaluating the peeling of the coated layer.

Evaluation norms;

A: No peeling of the coated layer was observed.

C: Peeling of the coating layer was observed.

Damage on cleaning blade:

After printing of 100,000 sheets, the cleaning blade was released from the image forming apparatus and the occurrence of damages at the portion contacted with the edge of the coated layer was visually observed.

Evaluation norms;

A: No damage was observed on the cleaning blade at the portion contacted with the edge of the coated layer.

C: Damages were observed on the cleaning blade at the portion contacted with the edge of the coated layer.

<Evaluation of Image>

An original image having a character image with a pixel ratio of 7%, a portrait image (a dot image including halftone), a solid white image and a solid black image each having the same quarter area was printed on A4 size neutral paper having a weight of 64 g/m². Thus obtained toner images were subjected to evaluation.

Fog:

Absolute reflection density of the neutral paper before printing was measured at 20 points and the averaged value of the measured results was defined as the density of the white paper. Then the density of the solid image area of the printed image was similarly measured at 20 points and averaged. The difference between the white paper density and the density of the white image area on the print was evaluated as the fog density. The measurement was carried out by Macbeth reflection densitometer RD-918.

Evaluation norms;

A: Fog density were 0.005 or less on initial print and on 100,000^{th} prints; good.

B: The fog on the initial print was not more than 0.05, and that on the 100,000^{th} print was not more than 0.01; no problem for practical use.

C: Both of the fog densities on the initial print and 100,000^{th} print were 0.01 or more; problems should be caused in the practical use.

Black spot:

After the sprinting of 100,000 sheets, a solid white image was further printed for 100 sheets for evaluation of the black spot occurrence. The evaluation was based on the number of visually observable black spot per A4 size hard copy which had a diameter of not less than 0.4 mm and occurred in a cycle agreed with the cycle of the photoreceptor.

Evaluation norms;

A: The occurring frequency of the black spot was not more than 3 per A4 size copy in the entire hard copies; good.

B: One or more hardcopies having the black spots of from 4 to 10 per A4 size occurred in the entire hard copies; no problem was caused in the practical use.

C: One or more hardcopies having the black spots of 11 or more per A4 size occurred in the entire hard copies; problems should be caused in the practical use.

Image density:

The image density was evaluated by the density at the solid black area of the printed image. The image density was a relative value when the reflection density of the paper was set at 0. The measurement of the density was performed by Macbeth densitometer RD-918.

Evaluation norms;

A: The image densities of both of the initial print and the 100,000^{th} print were 1.2 or more; good.

B: The density of the initial print was not less than 1.2 and that of the 100,000^{th} print was not less than 1.0; no problem was caused in the practical use.

C: The image densities of both of the initial print and the 100,000^{th} print were less than 1.0; problems should be caused in the practical use.

Sharpness:

After printing of 100,000 prints, a character image containing 3-point and 5-point characters was printed and resulted image of the characters was visually evaluated.

Evaluation norms;

A: Both of the 3-point and 5-point characters were clearly and legibly printed; good.

B: The 3-point characters were partially illegible but the 5-point characters were easily legible; no problem was caused in the practical use.

C: The 3-point characters were almost illegible and the 5-point characters were partially or entirely illegible: Problems should be caused in the practical use.

Evaluated results are listed in Table 2.

TABLE 2

| | Photo- | Visual | | Image evaluation | | | |
|---|---|---|---|---|---|---|---|
| | receptor | evaluation | | | Image | | Black |
| | No. | *1 | *2 | Fog | Density | Sharpness | spot |
| Example 1 | 1 | A | A | A | A | A | A |
| Example 2 | 2 | A | A | B | A | B | A |
| Example 3 | 3 | A | A | B | A | A | A |
| Example 4 | 4 | A | A | A | A | A | A |
| Example 5 | 5 | A | A | B | A | A | A |
| Example 6 | 6 | A | A | A | A | A | A |
| Example 7 | 7 | A | A | A | A | A | A |
| Example 8 | 8 | A | A | A | A | B | A |
| Example 9 | 9 | A | A | A | A | A | A |
| Comparative | 10 | A | A | B | B | C | C |
| example 1 | | | | | | | |
| Comparative | 11 | A | A | C | B | B | C |
| example 2 | | | | | | | |
| Comparative | 12 | A | A | C | B | C | C |
| example 3 | | | | | | | |
| Comparative | 13 | C | C | C | B | B | B |
| example 4 | | | | | | | |

*1: Peeling of coated layer at the edge portion,
*2: Damage on cleaning blade

Table 2 displays that in Examples 1 through 9 each employing Photoreceptors 1 through 9, respectively, no peeling of the coated layer occurred, no damage on the cleaning blade occurred, and no problem was caused on the black spot and fog, and a toner image having high density and high sharpness, which is characteristic of the wet developing method, can be obtained. On the other hand, it is understood by Comparative examples 1 through 4 employing Photoreceptors 10 through 13 that the problem is caused in any one of the evaluation items.

### Examples 10 to 14

(Preparation of Resin Solution S)

To 100 parts by weight of chain dimethylsilicone SF200-0.65, manufactured by Toray-Dow Corning Co., Ltd., as a solvent, 30 parts by weight of a monomer of one terminal methacryloxy-modified silicone resin MF0711, manufactured by Chisso Co., Ltd., 65.5 parts by weight of vinyl acetate, 3.5 parts by weight of N-vinyl-2-pyrrolidone and 1.0 part by weight of (ethylene glycol)methacrylate were added and the resultant solution was kept at 80° C. in nitrogen atmosphere. And then 1.7 parts by weight of an initiator of azobisisobutylnitrile (AIBN) was added and polymerization was carried out for 4 hours to prepare a resin solution containing 49% by weight of a resin having a polymerization ratio of 98% by weight. After that, the solvent was replaced by cyclic silicone DC345, manufactured by Toray-Dow Corning Co., Ltd. Thus a resin solution S having a resin concentration of 50% by weight was obtained.

(Preparation of Resin Capsuled Black Colorant Powder B)

One hundred parts by weight of carbon black Regal 250R, manufactured by Cabot Co., Ltd., was treated by 30 parts by weight of aminoalkyd resin to obtain a resin capsuled black colorant.

(Preparation of Resin Capsuled Cyan Colorant Powder C)

One hundred parts by weight of a colorant of β-type copper phthalocyanine blue (C.I. Pigment Blur 15.3) was treated by 30 parts by weight of aminoalkyd resin to obtain a resin capsuled cyan colorant.

(Preparation of Resin Capsuled Magenta Colorant Powder M)

One hundred parts by weight of a colorant of Rhodamine (C.I. Pigment Red 81.1) was treated by 15 parts by weight of aminoalkyd resin to obtain a resin capsuled magenta colorant.

(Preparation of Resin Capsuled Yellow Colorant Powder Y)

One hundred parts by weight of a colorant of insoluble disazo type acetoacetic acid arylide (C.I. Pigment Yellow 13) was treated by 5 parts by weight of aminoalkyd resin to obtain a resin capsuled yellow colorant.

(Preparation of Liquid Developer Black B-1)

Fifty eight parts by weight of a carrying liquid of chain dimethylsilicone SH200-50, manufactured by Toray-Dow Corning Co., Ltd., 34 parts by weight of the forgoing resin solution S, 8 parts by weight of the resin capsuled black colorant B, 5 parts by weight of liquid paraffin, and 0.25 parts by weight of tetraoctylbis(ditridecyl phosphite)titanate 46B, manufactured by Ajinomoto Co., Ltd., were kneaded and dispersed by a three roller kneader to prepare a black liquid developer. Thus the black liquid developer having a solid component concentration of 23.8% by weight and a viscosity of 12,000 mPa·s was obtained.

(Preparation of Liquid Developer Black B-2)

Fifty eight parts by weight of the carrying liquid of chain dimethylsilicone SH200-50, manufactured by Toray•Dow Corning Co., Ltd., 34 parts by weight of the forgoing resin solution S, 8 parts by weight of the resin capsuled black colorant B, 7 parts by weight of liquid paraffin, and 0.25 parts by weight of tetraoctylbis(ditridecyl phosphite) titanate 46B, manufactured by Ajinomoto Co., Ltd., were kneaded and dispersed by a three roller kneader to prepare a black liquid developer. Thus the black liquid developer having a solid component concentration of 23.3% by weight and a viscosity of 9,000 mPa·s was obtained.

(Preparation of Liquid Developer Black B-3)

Sixty eight parts by weight of the carrying liquid of chain dimethylsilicone SH200-50, manufactured by Toray-Dow Corning Co., Ltd., 34 parts by weight of the forgoing resin solution S, 8 parts by weight of the resin capsuled black colorant B, 30 parts by weight of liquid paraffin, and 0.25 parts by weight of tetraoctylbis(ditridecyl phosphite) titanate 46B, manufactured by Ajinomoto Co., Ltd., were kneaded and dispersed by a three roller kneader to prepare a black liquid developer. Thus the black liquid developer having a solid component concentration of 15.1% by weight and a viscosity of 180 mPa·s was obtained.

(Preparation of Liquid Developer Black B-4)

Sixty eight parts by weight of the carrying liquid of chain dimethylsilicone SH200-50, manufactured by Toray•Dow Corning Co., Ltd., 34 parts by weight of the forgoing resin solution S, 8 parts by weight of the resin capsuled black colorant B, 50 parts by weight of liquid paraffin, and 0.25 parts by weight of tetraoctylbis(ditridecyl phosphite) titanate 46B, manufactured by Ajinomoto Co., Ltd., were kneaded and dispersed by a three roller kneader to prepare a black liquid developer. Thus the black liquid developer having a solid component concentration of 16.1% by weight and a viscosity of 50 mPa·s was obtained.

(Preparation of Liquid Developer Cyan C-1)

Thirty parts by weight of a carrying liquid of cyclic silicone DC345, manufactured by Toray•Dow Corning Co., Ltd., 51 parts by weight of the forgoing resin solution S, 13 parts by weight of the resin capsuled cyan colorant C, 16 parts by weight of liquid paraffin, and 0.08 parts by weight of isopropyltriisostearoyl titante TSS, manufactured by Ajinomoto Co., Ltd., were kneaded and dispersed by a three roller kneader to prepare a cyan liquid developer. Thus the cyan liquid developer having a solid component concentration of 38.5% by weight and a viscosity of 8,600 mPa·s was obtained.

(Preparation of Liquid Developer Magenta M-1)

Sixteen parts by weight of a carrying liquid of cyclic silicone DC345, manufactured by Toray•Dow Corning Co., Ltd., 67 parts by weight of the forgoing resin solution S, 17 parts by weight of the resin capsuled magenta colorant M, 6 parts by weight of liquid paraffin, and 0.01 parts by weight of isopropyltriisostearoyl titante TSS, manufactured by Ajinomoto Co., Ltd., were kneaded and dispersed by a three roller kneader to prepare a magenta liquid developer. Thus the magenta liquid developer having a solid component concentration of 36.3W by weight and a viscosity of 5,600 mPa·s was obtained.

(Preparation of Liquid Developer Yellow Y-1)

Twenty one parts by weight of a carrying liquid of cyclic silicone DC345, manufactured by Toray•Dow Corning Co., Ltd., 67 parts by weight of the forgoing resin solution S, 17 parts by weight of the resin capsuled yellow colorant Y, 8 parts by weight of liquid paraffin, and 0.5 parts by weight of isopropyltriisostearoyl titante TSS, manufactured by Ajinomoto Co., Ltd., were kneaded and dispersed by a three roller kneader to prepare a yellow liquid developer. Thus the yellow liquid developer having a solid component concentration of 44.5% by weight and a viscosity of 5,800 mPa·s was obtained.

### Example 10

A black image was formed by the image forming apparatus shown in FIG. 3 and evaluated. In the image forming apparatus, the photoreceptor No. 1 and the foregoing developer B-1 was employed. The evaluation was performed in the same manner as the evaluations of examples 1-9 and comparative examples 1-4.

### Examples 11 to 13

Combinations of the photoreceptor and the developer listed in Table 3 were evaluated in the same manner as in Example 10.

### Example 14

A color images was formed by the combination of Photoreceptor No. 1, and the developers B-2, Y-1, M-1 and C-1 by the image forming apparatus shown in FIG. 3 and evaluated.

Color reproducibility:

The solid images of the secondary colors (red, green and blue) formed by the Y, M and C toners on the first copy and the 100^{th} copy were measured by Macbeth Color-Eye 7000, and the difference between each of the color solid images of the first copy and the 100^{th} copy was calculated by CMC (2:1) color differential equation.

A: The color difference was less than 2; good.

B: The color difference was 2 to 3; not problem.

C: The color difference was more than 3; not acceptable since a problem was caused in practical use.

TABLE 3

| | | | | Concen- | |
|---|---|---|---|---|---|
| | Photo- | | | tration | Within or |
| | receptor | Developer | Viscosity | (weight- | without |
| Example | No. | No. | (mPa · s) | %) | invention |
| Example | 1 | B-1 | 12000 | 23.8 | Within |
| 10 | | | | | |
| Example | 1 | B-2 | 9000 | 23.3 | Within |
| 11 | | | | | |
| Example | 1 | B-3 | 180 | 15.1 | Within |
| 12 | | | | | |
| Example | 1 | B-4 | 50 | 16.1 | Within |
| 13 | | | | | |
| Example | 1 | B-2/Y-1/ | 5600-9000 | 23.3-44.5 | Within |
| 14 | | M-1/C-1 | | | |

Evaluation results of examples 10-14 are listed in Table 4.

TABLE 4

| | Visual evaluation | | | | | | |
|---|---|---|---|---|---|---|---|
| | Peeling | | | | | | |
| | at the | Damage | | | | | |
| | edge of | on | Image evaluation | | | | |
| | coated | cleaning | | Image | | Black | |
| Example | layer | blade | Fog | density | Sharpness | spot | *1 |
| Example | A | A | A | A | A | B | — |
| 10 | | | | | | | |
| Example | A | A | A | A | A | A | — |
| 11 | | | | | | | |
| Example | A | A | A | A | A | A | — |
| 12 | | | | | | | |
| Example | A | AA | B | A | B | A | — |
| 13 | | | | | | | |
| Example | A | A | A | A | A | A | A |
| 14 | | | | | | | |

*1: Color reproductibility

As is cleared in Table 4, the developer is stable, the coated layer was not peeled, no damage is caused, the problems of the black spot and the fog are not caused, and an toner image having high density and high sharpness which is the feature of the wet development can be obtained in Examples 10 to 14 employing the photoreceptor and the high viscous developer according to the invention. Furthermore, in the case of the color image, the developer is not degraded and image superior in the color reproducibility can be stably obtained.

What is claimed is:

1. An electrophotographic image forming apparatus comprising:
a photoreceptor which comprises an intermediate layer containing inorganic particles and a binder between an electroconductive substrate and an uppermost layer;
a developing unit which develops an electrostatic latent image formed on the photoreceptor to make a toner image, the developing unit utilizing a liquid developer containing a toner and a carrier liquid; and
a transferring unit which transfers the toner image to a recording material,
wherein a number-average primary particle diameter of the inorganic particles is in the range of 5 to 300 nm, and the intermediate layer is covered with the uppermost layer.

2. The electrophotographic image forming apparatus of claim 1, wherein the liquid developer comprises the toner dispersed in the carrier liquid, and has a viscosity from 50 to 12000 mPa·s.

3. The electrophotographic image forming apparatus of claim 1, wherein the uppermost layer is a photosensitive layer.

4. The electrophotographic image forming apparatus of claim 1, wherein the inorganic particles comprises N-type semi-conductive particles.

5. The electrophotographic image forming apparatus of claim 1, wherein the inorganic particles are inorganic oxide particles.

6. The electrophotographic image forming apparatus of claim 1, wherein the inorganic particles include zinc oxide particles.

7. The electrophotographic image forming apparatus of claim 1, wherein the inorganic particles include inorganic particles applied a surface treatment.

8. The electrophotographic image forming apparatus of claim 1, wherein the thickness of the intermediate layer is in the range of 0.2 to 40 μm.

9. The electrophotographic image forming apparatus of claim 1, wherein the binder of the intermediate layer comprises a polyamide resin.

10. The electrophotographic image forming apparatus of claim 1, wherein the photoreceptor includes a photosensitive layer which includes at least a charge generation layer and a charge transfer layer accumulated in this order on the intermediate layer.

11. The electrophotographic image forming apparatus of claim 10, wherein the charge generation layer is covered with the uppermost layer.

12. The electrophotographic image forming apparatus of claim 11, wherein the uppermost layer is the charge transfer layer.

13. The electrophotographic image forming apparatus of claim 11, wherein the uppermost layer is a protective layer accumulated on the charge transfer layer.

14. An electrophotographic image forming method comprising:
forming an electrostatic latent image on a photoreceptor which comprises an intermediate layer containing inorganic particles and a binder between an electroconductive substrate and an uppermost layer;
developing an electrostatic latent image formed on the photoreceptor to make a toner image, by utilizing a liquid developer containing a toner and a carrier liquid; and
transferring the toner image to a recording material,
wherein a number-average primary particle diameter of the inorganic particles is in the range of 5 to 300 nm, and the intermediate layer is covered with the uppermost layer.
